(19) United States
(12) Patent Application Publication
(10) Pub. No.: US 2004/0180316 A1
(43) Pub. Date: Sep. 16, 2004

(54) Interactive book system based on ultrasonic position determination

(76) Inventor: Shih-Chin Yang, Fremont, CA (US)

Correspondence Address: SHIH-CHIN YANG, 34361 Windsong Terrace, Fremont, CA, 94555, US

(21) Appl. No.: 10/390,271

(22) Filed: Mar. 15, 2003

(51) Int. Cl. G09B 5/00

(52) U.S. Cl. 434/317

(57) ABSTRACT

A system for readers to interact with printed materials (201) such as books is provided. The system consists of an ultrasonic pointing unit (216), an ultrasonic base unit (213), a control unit (220) and a response unit (240). The reader interacts with the printed material (201) by placing the ultrasonic pointing unit (216) on various areas of the printed page (10). Ultrasonic wave propagates between the ultrasonic point unit (216) and ultrasonic base unit (213). By measuring multiple time-of-flight of ultrasonic wave, the location of the ultrasonic pointing unit (216) could be determined, and the device makes appropriate audio or other responses. A printed material (201) is thereby transformed into an interactive experience with various sound or visual effects. The sound effects or other response data (540) are stored in data storage (230) accessible by the control unit (220). Any number of different printed materials (201) can be used as long as the specific response data (540) for each different printed material (201) is stored in data storage (230) accessible by the control unit (220).

### CROSS-REFERENCE TO RELATED APPLICATION

Not applicable.

### BACKGROUND

1. Field of Invention

The present invention relates generally to the area of electronic entertainment and educational devices and, more specifically, to a device that allows a reader to interact with printed material such as books.

2. Description of Prior Art

There are various devices to associate audio and visual output with visual icons on printed material. When a reader points on a visual icon such as a word, picture, then the corresponding sound or flashing light would be produced. Those devices have the benefit of making reading a more interactive process, and find their success in various applications. In case of learning language, when a reader points a word, the corresponding sound would be pronounced. The key of those devices is to identify where a reader points at, there are currently several system and methods.

In a voice book system described by U.S. Pat. No. 6,064,855, a detecting device which is electrically communicated with the audio device for detecting which page sheet of the voice book is turned in so that the audio device will select the particular sound messages with respect to the content of that turned in page sheet. Even though this system adds sound to printed book, it could not provide sound for individual text or graphics on the same page.

U.S. Pat. No. 5,356,296 shows an audio storybook that incorporates raised characters within the storybook, which are electronically connected to sound synthesizer and reproduction apparatus associated with a book. Since the storybook requires special processing to provide raised characters and special means to connect those raised characters to external electronics, the cost of producing different storybooks for the system is high.

U.S. Pat. No. 5,749,735 presents an interactive book having a mechanism for generating a plurality of sensory outputs. Since the device requires separate function initiators corresponding to visual indicia printed on a book, a user needs to look for a function initiator whenever he or she wants to get output for the visual indicia, the usage of this device is not intuitive.

U.S. Pat. No. 4,884,974 shows an interactive talking book and audio player. The device requires a ROM module attached to its back cover. Also, each page requires a special bar code. So the book used in such a device requires special processing unlike traditional books. Also, the device fails to provide different sound for different visual icons on the same page.

U.S. Pat. No. 5,851,119 shows an interactive storybook that requires a touch sensitive pad. The book is able to provide particular sound corresponding to (X, Y) coordinates. However, the touch sensitive pad might not be able to sense through a thick book. Also, the required area of touch sensitive pad is proportional to size of book, thus it could be very expensive to make.

In a system described by U.S. Pat. No. 5,466,158, the device comprises a base unit with a sensitive upper surface on which is placed the printed material. The reader answers questions and solves challenges posed in the printed material by exerting pressure on specially marked areas of the printed page. The sensitive surface translates the pressure into electrical signals which signify the location of the pressure, and the device makes appropriate audio or other responses. Since the sensitive surface has an array of mechanical switches, if a book is large and high resolution is required, the sensitive surface would be difficult to make and with high cost. Also, for a thick book, the sensitive upper surface might not be able to sense the pressure.

Likewise, for a system described in U.S. Pat. No. 5,686,705, the system has a conductive material layer, over which a non-conductive skin having graphics printed thereon can be placed. For a thick book, signal might not be able to penetrate, thus the selected point might not be able to be determined. Also, the cost of such a system is proportional to the size of the conductive material, thus it becomes expensive for large books. Also, since it required conductive material underneath a book, so the device would be difficult to carry around when it is large.

There is also a device using a digitizing tablet made of wire grid. Such a device has same drawbacks, it doesn't work with a thick book, also it is expensive to make and difficult to carry for books with large area.

### SUMMARY

It is an object of present invention to enhance reading experience of printed material.

It is an object of the present invention to provide a compact and portable device for interaction with content of printed material;

It is a further object of the present invention to provide a portable device that associates visual icons printed on printed material with various appropriate sound effects;

It is an additional object of the present invention to provide a device that allows intuitive operation;

It is another object of the present invention to provide a flexible device that works with any properly designed printed material.

It is another object of the present invention to operate with 3D objects located on 2D surface.

These and other objects are accomplished by an ultrasonic position determination device, together with a printed material placed in a known location relative to the device, a control unit and a response unit. Generally, the printed material will be an illustrated work of the type generally called books. However, other types of printed material even a 2D surface over which 3D objects locates can readily be adapted to work with the present invention.

The ultrasonic position determination device includes a pointing unit and a base unit. A reader uses the pointing unit to select a visual icon that he or she is interested in. The pointing unit and base unit together determine the coordinate that the reader selects. This coordinate is input to the control unit, then the control unit would search for the response data, e.g. sound, then present the response data to the reader via a response unit, e.g. a speaker.

The pointing unit has at least one ultrasonic transducer, and the base unit at least 2 ultrasonic transducers at a known distance with respective to each other. Thus, at least 2 time-of-flight of ultrasonic wave could be measured between pointing unit and base unit. Time-of-flight could be translated to distance given sound speed. And further, by means of triangulation, 2-dimensional coordinate could be determined with 2 distances between pointing unit and base unit. And 3-dimensional coordinate could be determined with 3 distances between pointing unit and base unit.

There are other methods to determine position of ultrasonic pointing unit other than triangulation, they all based on principle of time-of-flight. Triangulation is used here to set as an example of using ultrasonic technique to determine position of ultrasonic pointing unit. The system has the ability to determine position of ultrasonic pointing unit at least 1 meter in each dimension.

The control unit could be a microprocessor or an application specific IC that could accept position of pointing device as input, and search for response data corresponding to that position, then optionally processes (e.g. decodes) the found response data (e.g. ADPCM speech or MP3 music), then output the response data through designated response unit (e.g. a speaker).

The response data could be stored in internal data storage, e.g. NAND flash memory, masked ROM, etc. Or it could be stored in external data storage, e.g. nonvolatile Memory card, optical disk, hard disk, etc. Data storage could be accessed by control unit through various wired or wireless channel, e.g. data bus, USB port, RS-232 port, Bluetooth, 802.11b, Ethernet, etc.

The response unit could include various sensible outputs, e.g. speaker, LEDs, LCD, etc. It accepts input from control unit, and presents the response data to the reader.

Since the present invention is capable of determining a reader's selected point and producing corresponding sound or other sensible outputs, so reading would become more entertaining and educative. It is also interactive, since a reader gets a chance to input and receive output. It is intuitive, since a reader uses an ultrasonic pointing unit (e.g. a pen with ultrasonic transducer) to select a visual icon, and get what he or she wants to hear or see or touch.

### DRAWING FIGURES

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 shows a regular page of printed material

FIG. 2 shows the functional block diagram of present invention;

FIG. 3 outlines the principle of ultrasonic position determination device;

FIG. 4 illustrates one embodiment of ultrasonic position determination device based on threshold;

FIG. 5 shows one embodiment of logical organization of response data in data storage

FIG. 6 shows a regular page having a plurality of visual icons and their corresponding rectangular area;

FIG. 7 shows one embodiment of response unit;

FIG. 8 shows the perspective view of an interactive book system;

FIG. 9 is the open view of interactive book system, and

FIG. 10 is the perspective view of one embodiment of ultrasonic pointing unit system.

### REFERENCE NUMERALS IN DRAWINGS

10 Regular page

11 Page number

13 Graphic

16 Text

200 Functional block diagram

201 Printed material

210 Ultrasonic position determination device

213 Ultrasonic base unit

216 Ultrasonic pointing unit

220 Control unit

230 Data storage

240 Response unit

270 Control unit interface with ultrasonic position determination device

300 Triangulating position of ultrasonic pointing unit

310.aUltrasonic transducer of base unit

310.bUltrasonic transducer of base unit

313 Distance between 310.a and 310.b

320 Ultrasonic transducer of pointing unit

321.a Distance between 320 and 310.a

321.b Distance between 320 and 310.b

323 Coordinate of ultrasonic pointing unit

400 One embodiment of ultrasonic position determination device

410 Micro-controller

412 User trigger interrupt

422 Transmit ISR

424.a Receive ISR a

424.b Receive ISR b

426 Position calculation routine

430.a, 430.b Counter

433 4 MHz crystal oscillator

440 40 KHz pulse generator

450.a, 450.b signal amplifier

453.a, 453.b signal comparator

500 One embodiment of organization of response data

510 Response data record

520 Identifier

530 Area descriptor

540 Response data

620 Upper-leftmost corner of rectangle

623 Length of rectangle

626 Width of rectangle

700 One embodiment of response unit

711 Audio driver software

713 Audio circuit

715 Speaker

721 LCD driver software

723 LCD driver circuit

725 LCD

731 LED driver software

733 LEDs driver circuit

735 LEDs

800 Preferred embodiment of present invention

841 Keypad

843 Power switch

850 Memory card

900 Open view of preferred embodiment 800

910 PCB

940 Microprocessor of control unit

950 Micro-controller of ultrasonic position determination device

953 Memory card connector

961 ICs for driving speaker, LEDs, LCD

1000 One embodiment of ultrasonic pointing unit

1001 Tip of embodiment 1000

1003 cable of embodiment 1000

### DETAILED DESCRIPTION

This chapter explains present invention in such greater detail so any person skilled in the art would be readily able to make a product based on the outlined principle. One preferred embodiment of present invention is shown, it is obvious that various embodiments could be derived from principle of present invention.

“Visual icon” used herein refers to graph, text, picture, photo or any other objects that conveys meanings ion, a visual icon could be 2 or 3 dimensional.

“Printed material” used herein refers to book, magazines or other collection of sheets that have a plurality of visual icons on them.

“Data storage” used herein refers to any device that could store data, such as memory cards (e.g. compact flash card, smartmedia card, secure digital card, multimedia card, etc.), optical disk (e.g. CD-ROM, DVD-ROM), magnetic media (e.g. hard drive, tape).

“Response data” used herein refers to data that responds to a reader's input. It could be data that represents sensible output such as sound, speech, music, flashing of LEDs (Light emitting devices), picture, video or motion emulation shown on LCD (Liquid crystal display), or control of internal components such as volume control, brightness control of LCD, change of page, etc.

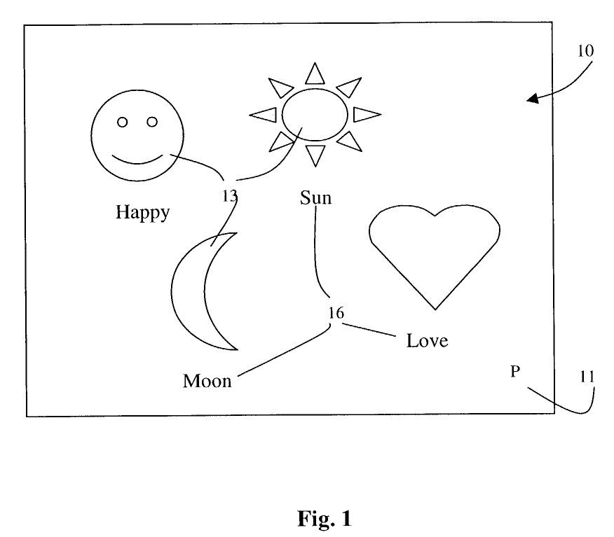

FIG. 1 shows a regular page 10 of printed material. On page 10, several graphics 13 and texts 16 are printed. This regular page 10 is not interactive by nature, since it does not accept user input nor produce output. An object of present invention is to provide interactivity for a regular page 10. Another object of present invention is intuitive usage, when a reader points at a visual icon like graphic 13 or text 16 or page number 11, a response would be immediately provided by present invention. It is another object of present invention to work with a regular page that does not require special attachment of buttons or electronics on it. Those objects collectively would make this system more easy to use, more fun to use and cheaper to produce.

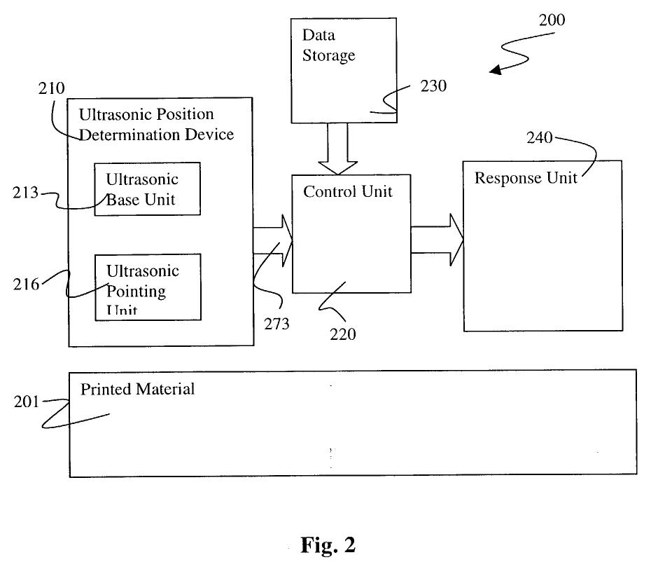

FIG. 2 depicts the functional block diagram 200 of presentation. It is shown that present invention consists of a printed material 201, an ultrasonic position determination device 21 0, a control unit 220, data storage 230 and a response unit 240. Ultrasonic position determination device 210 further consists of an ultrasonic base unit 213 and an ultrasonic pointing unit 216. Ultrasonic pointing unit 216 is used by a user to point at a visual icon on a regular page 10 of printed material 201 that he or she would like to interact with. Once said visual icon is pointed at, ultrasonic position determination device 210 would be able to calculate the coordinate of ultrasonic pointing unit 216. Said coordinate is input to control unit via interface 273. Based on said coordinate, control unit would search for response data correspond to it in data storage 230. Said response data could be processed and destine for its output via response unit 240, or it could be used as control data for other components like volume control. Response unit 240 may include a plurality of output such as speaker for audible response data, LEDs or LCD for visual effect. It is thus the great advantage of present invention, since it provides an intuitive way for a user to point at a visual icon then get the response. It is another great advantage of present invention since it employs ultrasonic position determination device 210. Unlike prior arts that generally use a sensor board placed underneath printed material, present invention doesn't require said sensor board, thus make it more economical to accommodate large and thick printed material.

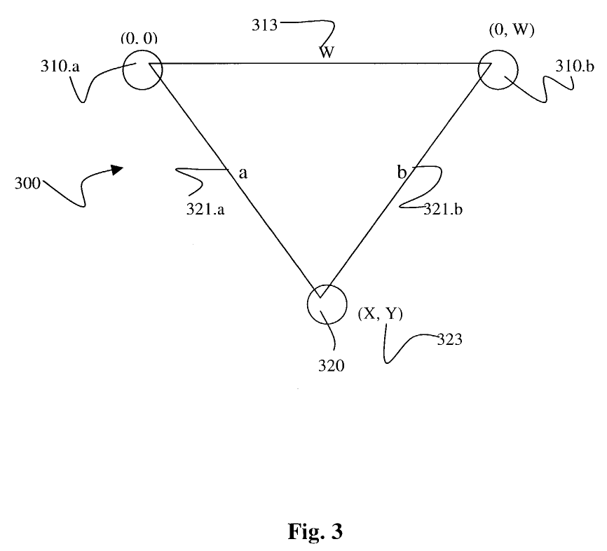

FIG. 3 outlines the principle 300 of ultrasonic position determination device. Ultrasonic base unit includes a pair of ultrasonic transducers 310.a and 310.b located apart at a known distance “W” 313. Ultrasonic pointing unit includes an ultrasonic transducer 320. Given measured distance “a” 321.a between transducers 310.a and 320, as well as distance “b” 321.b between transducers 310.b and 320. Position of ultrasonic pointing unit, (X, Y) 323, could be triangulated using “W” 313, “a” 321.a and “b” 321.b. The same principle could be applied to a 3 dimensional space as well. It is a known and mature technique to measure distance using ultrasonic wave, which derive distance by measuring time-of-flight of ultrasonic wave propagating between 2 corresponding ultrasonic transducers. A common technique is to measure time-of-flight by threshold.

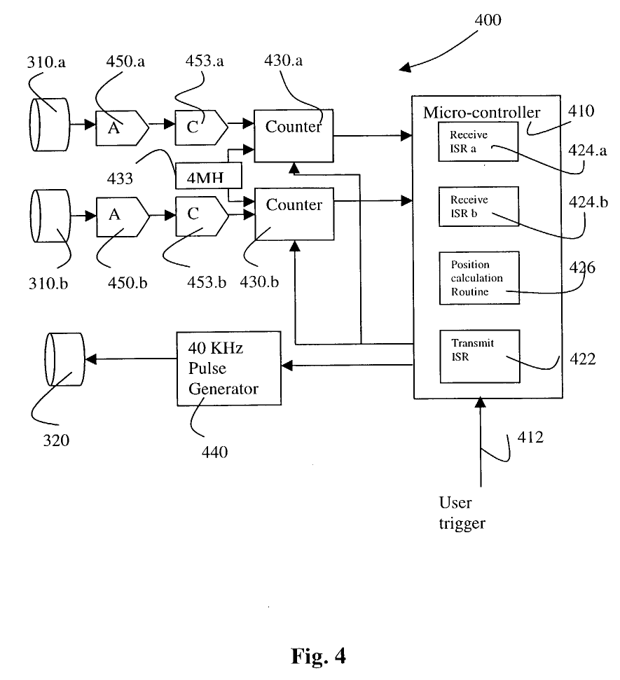

FIG. 4 illustrates one embodiment 400 of ultrasonic position determination device based on threshold. The device decides arrival of ultrasonic wave when its received signal level exceeds a threshold. The use of threshold is to avoid wrong decision if background noise exists. A 4 MHz crystal oscillator 433 clocks 2 counters 430.a and 430.b, which are initially reset to zero. When a user points at a visual icon using ultrasonic pointing unit 216, an interrupt 412 to micro-controller 410 is triggered. Transmit interrupt service routine 422 is invoked to serve the interrupt, which in turn triggers the 40 KHz pulse generator 440 to produce 20 cycles of pulse, which in turn is converted to ultrasonic wave transmitted by ultrasonic transducer 320 of ultrasonic pointing unit 216. In the mean time, counters 430.a, 430.b are triggered to run according to the clock. Said transmitted ultrasonic wave propagates then is received by ultrasonic transducers 310.a, 310.b of ultrasonic base unit 213. Said received signals are amplified by stages of 450.a, 450.b respectively, then are compared against a threshold by comparators 453.a, 453.b respectively. Once signal level exceeds said threshold, comparator 453.a, 453.b produce a pulse respectively, which stops the running of counters 430.a, 430.b respectively. Interrupts 414.a, 414.b indicates the stop of counter 430.a and 430.b respectively. Receive interrupt service routines 424.a, 424.b serve interrupts 414.a, 414.b respectively. Receive interrupt service routines 424.a, 424.b read counters 430.a, 430.b respectively. Counter values are converted to time by multiplying with period of 4 MHz crystal oscillator. Thus distance “a” 312.a between transducers 320 and 310.a could be calculated by multiplying time with sound-speed, so does distance “b” 312.b between transducers 320 and 310.b. Position calculation routine 426 is invoked to calculate the position (X, Y) 323 of ultrasonic pointing unit 216.

Other techniques exist to determine the position of ultrasonic pointing unit 216. In principle, they base on time-of-flight of ultrasonic wave.

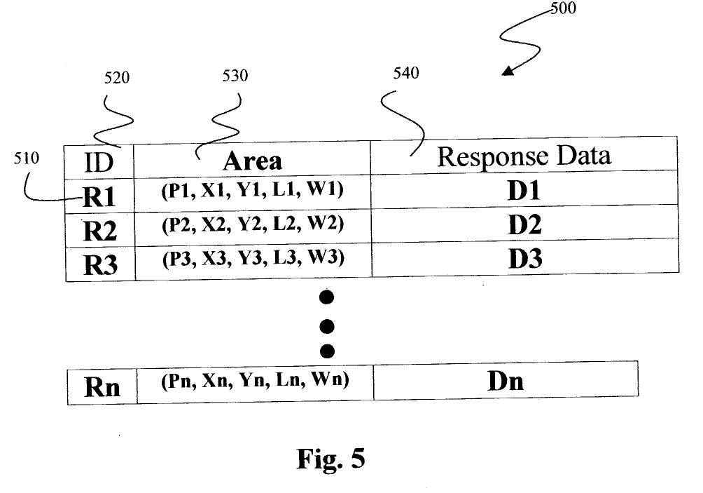

Once position (X, Y) 323 of ultrasonic pointing unit.216 is determined. (X, Y) 323 serve as input to control unit 220. Based on (X, Y) 323, control unit 216 searches for response data corresponding to (X, Y) 323 in data storage 230. In accordance with present invention, FIG. 5 shows one embodiment 500 of logical organization of response data in data storage 230. Data storage 230 contains a set of response data records 510, each response data record 510 consists of identifier 520, area descriptor 530, response data 540. Identifier 520 is used to uniquely identify a response data record. Area descriptor 530 is used to approximate an area occupied by a visual icon using a rectangle. Area descriptor is represented in a vector form (P, X′, Y′, L, W), P denotes page number, (X′, Y′) denotes coordinate of upper-leftmost point of said rectangle. L and H is the length and width of said rectangle, respectively. Response data 540 is data that responds to user. When control unit 220 receives position (X, Y) 323 of ultrasonic pointing unit 216, control unit 220 finds a response data record 510 whose associated area descriptor 530 having said rectangle covers (X, Y) 323. If a response data record is found, then control unit 220 retrieves the corresponding response data 540. Control unit 220 processes retrieved response data 540 according to its type. For example, it could decode ADPCM speech, MP3 music before direct them to audio output in response unit 240.

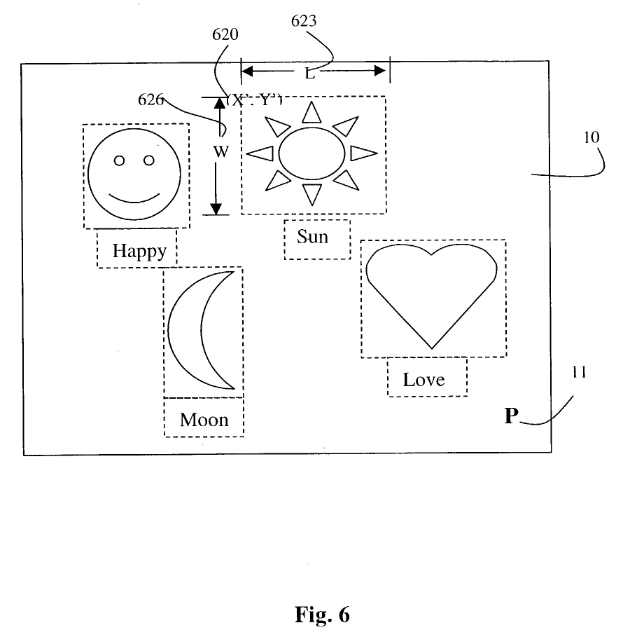

FIG. 6 shows a regular page 10 having a plurality of visual icons. Area of each visual icon is approximated by a rectangle describing by a page number P 11, coordinate of upper-leftmost point (X′, Y′) 620, length L 623, width 626. Once a visual icon is pointed at using ultrasonic point unit 216, the associated rectangle could thus be identified, and its associated response data 540 could be retrieved. Thus, the use of present invention is intuitive, since it provides “What you point is what you get” capability.

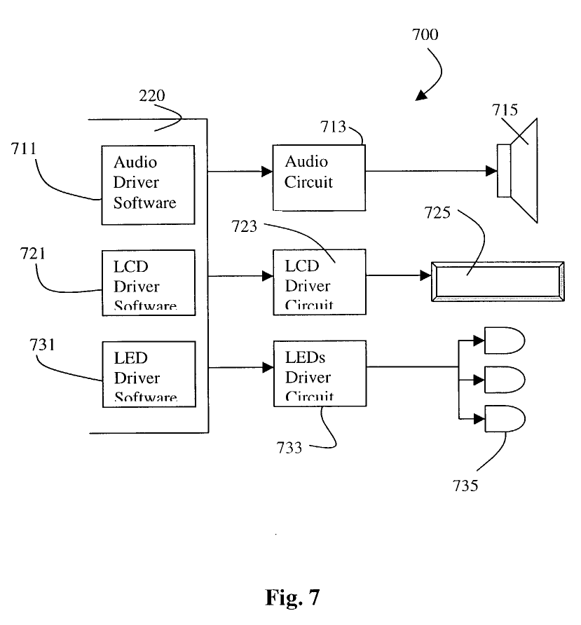

FIG. 7 shows one embodiment 700 of response unit 240. An audio circuit 713 drives a speaker 715 for audio output. Control unit 220 implements audio driver software 711 to output audio response data to audio circuit 713. A LCD driver circuit 723 drives a LCD for visual output. Control unit 220 implements LCD driver software 721 to output visual response data to LCD driver circuit. A LED driver circuit drives an array of LEDs. Control unit 220 implements LED driver software 731 to output visual response data. With the sound produced by speaker 715, graphics or video shown on LCD 735 or flashing LEDs 735, reading becomes an entertaining activity.

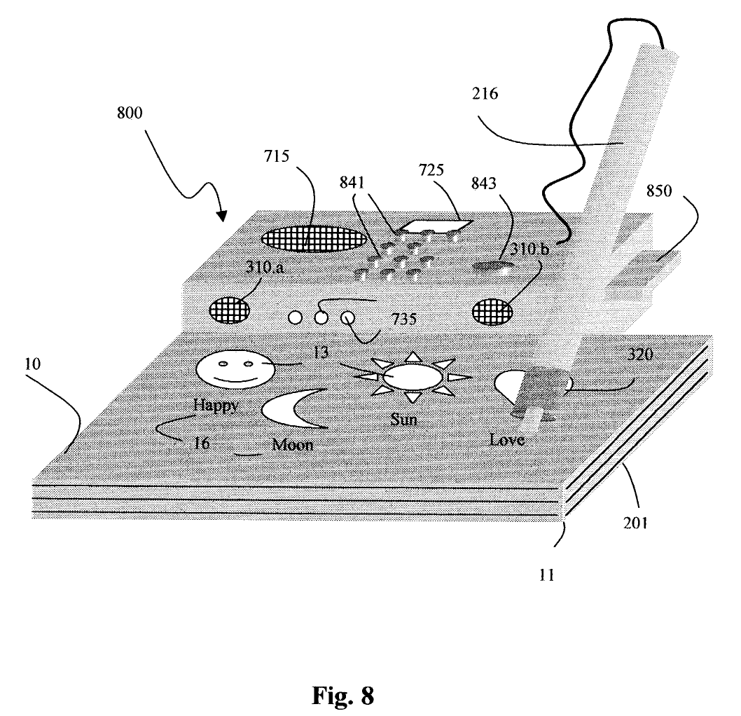

FIG. 8 shows the perspective view of an interactive book system 800 in accordance with present invention. Interactive book system 800 includes a printed material 201. Printed material 201 consists of at least one regular page 10 on which several graphics 13 and texts 16 are printed. Interactive book system further includes a ultrasonic position determination device 210 (not shown on this Figure). Ultrasonic position determination device 210 further consists of an ultrasonic base unit 213 (not shown here) and a ultrasonic pointing unit 216. Ultrasonic pointing unit 216 has the shape of a pen, thus making it natural to use. Ultrasonic base unit 213 further includes 2 ultrasonic transducers 310.a and 310.b. Ultrasonic pointing unit 216 further includes an ultrasonic transducer 320. Interactive system book 800 further includes a memory card 850 where response data 500 is stored. Memory card 850 is accessible by control unit 220 (not shown on this Figure) to retrieve response data 540. Interactive system book 800 further includes a keypad 841 for user to enter page number 11, and a power switch 843 for turning on or off the system. Interactive system book 800 further includes a response unit 240 (not shown on this Figure) to respond to a user's input. Response unit 240 further consists of a speaker 715, LEDs 735, a LCD 725. Excluding printed material 201, interactive book system 800 could be made in a 6″×3″×2″ form, and it could work with printed material 201 as large as 24″×24″×1″ (e.g. a big book of maps). Unlike prior arts, it would impossible or very expensive to make a system with capabilities of present invention.

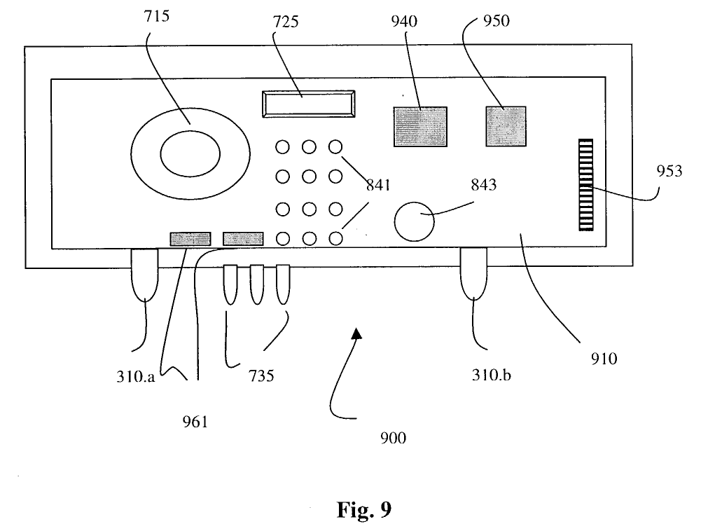

FIG. 9 is the open view 900 of interactive book system 800. Components are mounted on a PCB 910. Components invisible in FIG. 8 are shown in this figure. Microprocessor 940 is used in control unit 220. Micro-controller 950 is used in ultrasonic position determination device. There are ICs 961 for driving speaker, LCD and LEDs. And there is a connector 953 for memory card 850. Since the number of components of present invention is relatively small, so interactive book system 800 is relatively cheap to make.

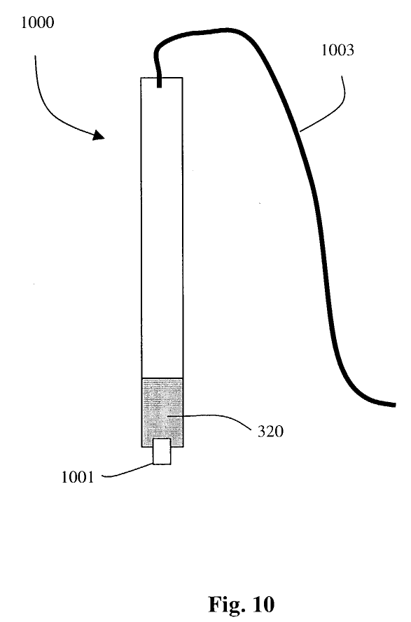

FIG. 10 is the perspective view of one embodiment 1000 of an ultrasonic pointing unit 216 used in interactive book system 800. Embodiment 1000 is a pen like unit with a tip 1001. Once tip 1001 is pressed, interrupt 412 would be triggered. And pulses of 40 KHz ultrasonic wave would be transmitted from ultrasonic transducer 320. Beam angle of ultrasonic transducer 320 is omni-directional, so embodiment 1000 could be used with ease without careful orientation toward ultrasonic transducers 310.a, 310.b of ultrasonic base unit 213. Embodiment 1000 further includes a cable 1003 connecting to micro-controller 410. Since embodiment 1000 is a pen like unit, so interactive book system 800 is natural and intuitive to use.

Operation

In accordance with present invention, use of preferred embodiment 800 consists of following steps

Turn on power of system by using power switch 843;

Turn to a page 10;

Enter a page number 11 by using keypad 841;

Select a visual icon by using ultrasonic pointing unit 216;

User would get immediate response corresponding to selected visual icon from speaker, LEDs or LCD.

The use of preferred embodiment 800 is shown to be easy, intuitive. The additional sound or visual effects provided by present invention could help engage readers to interact with content provided by said printed material 201. It is particularly useful for language learning or storytelling, and make reading a more entertaining process.

In accordance with present invention, principle of design and one preferred embodiment are shown in this chapter. It is clear that anyone skilled in the art would be readily to make different embodiments of present invention, thus the description herein should not be used to limit the scope of present invention.

What is claimed is:

1. An interactive system for allowing a reader to have interactions with a printed material, the interactions being determined according to text and graphics depicted in the printed material and the response data corresponding to the printed material. The system comprising:
an ultrasonic position determination device.
a printed material having at least one page, said printed material contains visual icons on its pages. Some of said visual icons have response data associated with them. Said response data is stored in data storage.
a response unit.
a control unit for locating the response data corresponding to a said visual icon.

2. The interactive book system of claim 1, wherein said ultrasonic position determination device further includes an ultrasonic base unit and an ultrasonic pointing unit.

3. An interactive system for allowing a reader to have interactions with a printed material, the interactions being determined according to text and graphics depicted in the printed material and the response data corresponding to the printed material. The system comprising:
an ultrasonic position determination device having an ultrasonic pointing unit and an ultrasonic base unit.
a printed material having at least one page, said printed material contains visual icons on its pages. Some of said visual icons have response data associated with them. Said response data is stored in data storage.
a response unit.
a control unit for locating the response data corresponding to a said visual icon according to the location of said ultrasonic pointing device.

4. The interactive book system of claim 3, wherein said ultrasonic position determination device further includes means for determining the position of said ultrasonic pointing unit by measuring time-of-flight of ultrasonic wave propagating between said ultrasonic pointing unit and base unit.

5. The interactive book system of claim 3, wherein said ultrasonic position determination device further includes means for determining the position of said ultrasonic pointing unit by measuring difference of time-of-flight of ultrasonic wave propagating between said ultrasonic pointing unit and base unit.

6. The interactive book system of claim 3, wherein said ultrasonic base unit includes at least 2 ultrasonic transducers. Said ultrasonic transducers are located at fixed positions relative to each other.

7. The interactive book system of claim 3, wherein said ultrasonic pointing unit includes at least one ultrasonic transducer.

8. The interactive book system of claim 4, wherein said means for determining the position of said ultrasonic pointing device include measurement of at least 2 time-of-flight of ultrasonic wave propagating between said ultrasonic pointing unit and base unit.

9. The interactive book system of claim 4, wherein said means for determining the position of said ultrasonic pointing device further include a method of calculating the position of said ultrasonic point device by triangulating multiple time-of-flight. The method comprising:
calculating the distance between a said ultrasonic transducer of said ultrasonic pointing unit and a said ultrasonic transducer of said ultrasonic base unit by multiplying said time-of-flight with sound speed.
calculating 2 dimensional position of said ultrasonic pointing unit based on at least 2 calculated distances between ultrasonic pointing unit and transducers of ultrasonic base unit and known distance between transducers of said ultrasonic base unit. Said calculation is based on triangulation.

10. The interactive book system of claim 4, wherein said means for determining the position of said ultrasonic pointing device further include a method of calculating the position of said ultrasonic point device by triangulating multiple time-of-flight. The method comprising:
calculating the distance between a said ultrasonic transducer of said ultrasonic pointing unit and a said ultrasonic transducer of said ultrasonic base unit by multiplying said time-of-flight and sound speed.
calculating 3 dimensional position of said ultrasonic pointing unit based on at least 3 calculated distances between ultrasonic pointing unit and transducers of ultrasonic base unit and known distance between transducers of said ultrasonic base unit. Said calculation is based on triangulation.

11. The interactive book system of claim 3, wherein said printed material is book.

12. The interactive book system of claim 3, wherein said printed material is magazine.

13. The interactive book system of claim 3, wherein said printed material is map.

14. The interactive book system of claim 3, wherein said printed material has 3D objects on a 2D surface.

15. The interactive book system of claim 3, wherein said printed material can be detached from other said units.

16. The interactive book system of claim 3, wherein said visual icon is text.

17. The interactive book system of claim 3, wherein said visual icon is graphic.

18. The interactive book system of claim 3, wherein said visual icon is picture.

19. The interactive book system of claim 3, wherein said visual icon is photo.

20. The interactive book system of claim 3, wherein said visual icon is symbol.

21. The interactive book system of claim 3, wherein said response data is audible data.

22. The interactive book system of claim 21, wherein said audible data is sound

23. The interactive book system of claim 21, wherein said audible data is speech.

24. The interactive book system of claim 21, wherein said audible data is music.

25. The interactive book system of claim 3, wherein said response data is visual data.

26. The interactive book system of claim 25, wherein said visual data is graphic.

27. The interactive book system of claim 25, wherein said visual data is picture.

28. The interactive book system of claim 25, wherein said visual data is photo.

29. The interactive book system of claim 3, wherein said response data is control data.

30. The interactive book system of claim 29, wherein said control data is volume of sound.

31. The interactive book system of claim 3, wherein said data storage is flash memory.

32. The interactive book system of claim 3, wherein said data storage is memory card.

33. The interactive book system of claim 3, wherein said data storage is external hard drive.

34. The interactive book system of claim 3, wherein said data storage is external optical drive.

35. The interactive book system of claim 3, wherein said response unit further includes an audio output.

36. The interactive book system of claim 3, wherein said response unit further includes visual output

37. The interactive book system of claim 35, wherein said audio output is a speaker.

38. The interactive book system of claim 35, wherein said audio output is a connection to external speaker.

39. The interactive book system of claim 36, wherein said visual output is one or more light emitting devices.

40. The interactive book system of claim 36, wherein said visual output is a LCD display.

41. The interactive book system of claim 36, wherein said visual output is a connection to external display.

42. The interactive book system of claim 3, wherein said control unit includes a microprocessor and access means to said data storage.

43. The interactive book system of claim 42, wherein said access mean is wired connection.

44. The interactive book system of claim 42, wherein said access mean is wireless connection.

45. The interactive book system of claim 42, wherein said microprocessor further includes a program to search and present said response data. The program comprises:
a routine to search for response data corresponding to said visual icon according to position of said ultrasonic pointing unit.
a routine to determine the response unit output for said response data.
a routine to present response data to said reader via said output of response unit.

46. The interactive book system of claim 45, wherein said program further include a routine to process response data before present response data.

47. The interactive book system of claim 45, wherein said program further include a routine to decode response data before present response data.

48. The interactive book system of claim 3, wherein the reader interacts with said printed material by positioning said ultrasonic pointing device on a said visual icon.

49. The interactive book system of claim 48, wherein said reader triggers the propagation of ultrasonic wave between said ultrasonic pointing unit and base unit.

50. The interactive book system of claim 49, wherein said time-of-flight of ultrasonic wave propagating between said ultrasonic pointing unit and base unit is measured.

51. The interactive book system of claim 50, wherein said position of ultrasonic pointing device is determined by said means for determining position of ultrasonic pointing device.

52. The interactive book system of claim 51, wherein said position of ultrasonic pointing device is input to said control unit.

53. The interactive book system of claim 52, wherein said control unit search for response data corresponding to said visual icon according to position of said ultrasonic pointing device.

54. The interactive book system of claim 53, wherein said control unit present response data to said reader via said response unit.
